(19) United States
(12) Patent Application Publication
(10) Pub. No.: US 2024/0176289 A1
(43) Pub. Date: May 30, 2024

(54) DEVELOPING DEVICE AND IMAGE FORMING APPARATUS

(71) Applicant: KYOCERA Document Solutions Inc., Osaka (JP)

(72) Inventors: Kenichi TAMAKI, Osaka (JP); Tamotsu SHIMIZU, Osaka (JP); Hiroshi YAMAZAKI, Osaka (JP); Junichi NAKAGAWA, Osaka (JP); Takuji WATANABE, Osaka (JP)

(73) Assignee: KYOCERA Document Solutions Inc., Osaka (JP)

(21) Appl. No.: 18/517,567

(22) Filed: Nov. 22, 2023

(30) Foreign Application Priority Data
Nov. 30, 2022 (JP) 2022-191111

(51) Int. Cl. G03G 21/20; G03G 15/09

(52) U.S. Cl. CPC G03G 21/206; G03G 15/0921

(57) ABSTRACT

A developing device includes a developer container and a developer carrying member. The developer carrying member includes a shaft, a sleeve that rotates while carrying toner on its outer circumferential face, and a magnet that extends along the axis of the developer carrying member. The developer container includes a duct, an intake port which opens above the developer carrying member and through which the inside of the developer container and the inside of the duct communicate with each other, and a first filter that covers the intake port. The edges of the first filter at one side and at the other side in the axial direction of the developer carrying member are both located within a range opposite the magnet as seen from the direction perpendicular to the axial direction.

### INCORPORATION BY REFERENCE

This application is based upon and claims the benefit of priority from the corresponding Japanese Patent Application No. 2022-191111 filed on Nov. 30, 2022, the entire contents of which are hereby incorporated by reference.

### BACKGROUND

The present disclosure relates to a developing device and an image forming apparatus.

Known developing devices include a developer container that stores developer containing toner. Known developing devices also include a developer carrying member that feeds toner to an image carrying member.

### SUMMARY

According to one aspect of the present disclosure, a developing device includes a developer container and a developer carrier. The developer container stores developer containing toner and has an opening at a position facing an image carrying member. The developer carrying member is arranged inside the developer container and is exposed out of the developer container through the opening. The developer carrying member carries toner to feed it to the image carrying member. The developer carrying member includes a shaft, a sleeve, and a magnet. The sleeve is supported so as to be rotatable about the shaft and rotates while carrying the toner on its outer circumferential face. The magnet is arranged inside the sleeve and extends along the axis of the developer carrying member. The developer container includes a duct, an intake port, and a first filter. The duct lets the air in the developer container flow out of it. The intake port opens above the developing roller. Through the intake port, the inside of the developer container and the inside of the duct communicate with each other. The first filter covers the intake port. The edges of the first filter at one side and at the other side in the axial direction of the developer carrying member are both located within a range opposite the magnet as seen from the direction perpendicular to the axial direction of the developing roller.

According to a second aspect of the present disclosure, an image forming apparatus includes the developing device described above.

### BRIEF DESCRIPTION OF THE DRAWINGS

FIG. 1 is a schematic diagram of an image forming apparatus including a developing device according to an embodiment.

FIG. 2 is a schematic diagram of and around an image forming portion including the developing device according to the embodiment.

FIG. 3 is a diagram showing the inside of the developing device according to the embodiment as seen from above.

FIG. 4 is a cross-sectional view of the developing device (a cross-sectional view cut along a plane perpendicular to the axis of a developing roller) according to the embodiment.

FIG. 5 is a schematic diagram showing the position where a first filter of the developing device is arranged according to the embodiment.

FIG. 6 is a diagram showing the results of tests performed to confirm the effect of the embodiment.

### DETAILED DESCRIPTION

Now, an image forming apparatus according to one embodiment of the present disclosure will be described taking a tandem-type color laser printer as an example. However, image forming apparatuses to which the present disclosure is applicable are not limited to color laser printers. The present disclosure can be applied to various image forming apparatuses such as monochrome printers and multifunction peripherals. In the following description, the direction perpendicular to a flat floor on which an image forming apparatus is installed is defined as the up-down direction.

<Overall Structure of an Image Forming Apparatus>

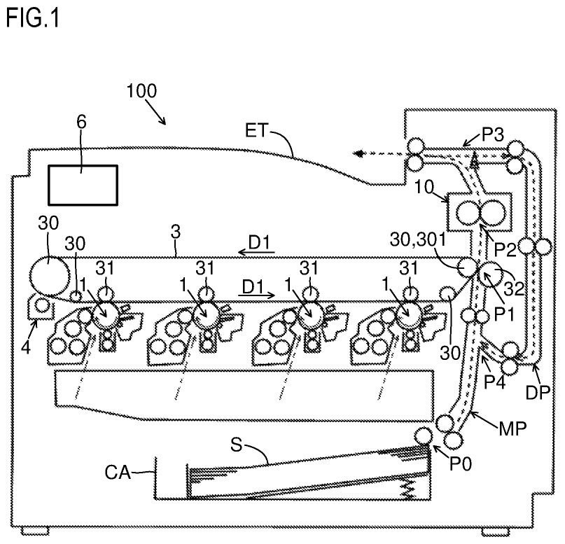

As shown in FIG. 1, an image forming apparatus 100 according to the embodiment includes a main conveying passage MP. The image forming apparatus 100 includes a sheet cassette CA. The sheet cassette CA is removably mounted in the main body of the image forming apparatus 100. In the sheet cassette CA, sheets S used in a print job are stored. The main conveying passage MP leads from a feeding position P0 of the sheets P from the sheet cassette CA via a transfer position P1 and a fixing position P2 to a discharge tray ET.

In a print job, a sheet S in the sheet cassette CA is fed from the feeding position P0 to the main conveying passage MP. The image forming apparatus 100 conveys the sheet S along the main conveying passage MP. Then, the image forming apparatus 100 prints an image on the sheet S being conveyed. In other words, the image forming apparatus 100 transfers a toner image to the sheet S being conveyed. At the transfer position P1, a toner image is transferred to the sheet S being conveyed.

The image forming apparatus 100 includes image forming portions 1 for four colors, namely cyan, magenta, yellow and black. Each image forming portion 1 forms a toner image of the corresponding color. Hereinafter, their structure will be described with focus on one image forming portion 1. The image forming portions 1 have basically similar structures; thus, for the structure of the other developing devices 2, reference is to be made to the following description and no overlapping description will be repeated.

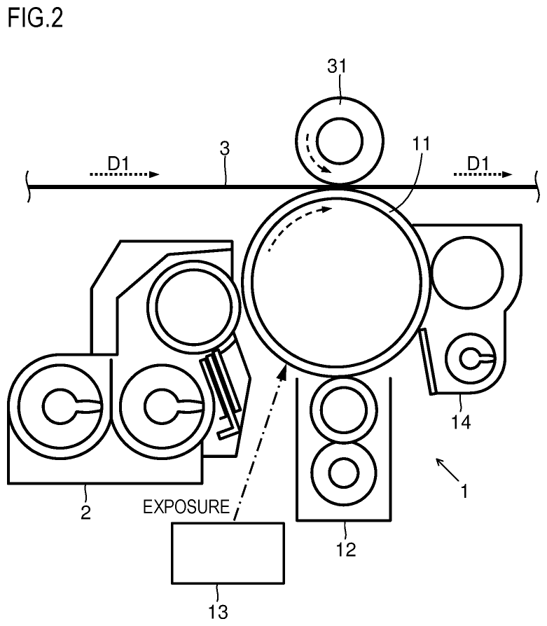

As shown in FIG. 2, the image forming portion 1 includes a developing device 2. The image forming portion 1 includes, in addition to the developing device 2, a photosensitive drum 11, a charging device 12, an exposure device 13, and a cleaning device 14. The photosensitive drum 11 corresponds to an “image carrying member”.

During image formation by the image forming portion 1, the photosensitive drum 11 rotates. In FIG. 2, the photosensitive drum 11 rotates clockwise. The charging device 12 electrostatically charges the outer circumferential face of the photosensitive drum 11. The exposure device 13 exposes to light the outer circumferential face of the photosensitive drum 11 to form on it an electrostatic latent image. Then, the developing device 2 feeds toner to the outer circumferential face of the photosensitive drum 11 to develop the electrostatic latent image into a toner image. The toner image on the outer circumferential face of the photosensitive drum 11 is primarily transferred to an intermediate transfer belt 3, which will be described later. The cleaning device 14 removes toner that remains on the outer circumferential face of the photosensitive drum 11 without being transferred to the intermediate transfer belt 3.

As shown in FIG. 1, the image forming apparatus 100 includes an intermediate transfer belt 3. The intermediate transfer belt 3 is an endless belt. The intermediate transfer belt 3 is stretched around and rotatably supported by a plurality of rollers 30. The intermediate transfer belt 3 makes contact with the outer circumferential face of the photosensitive drum 11 and, in that state, rotates (turns around) in the direction indicated by arrow D1 in the diagram.

The plurality of rollers 30 include a driving roller 301. One of the plurality of rollers 30 is the driving roller 301. The driving roller 301 is coupled to a belt motor (not shown) and rotates by receiving a driving force from the belt motor. The intermediate transfer belt 3, as the driving roller 301 rotates, rotates by following it. The other rollers 30 rotate by following the intermediate transfer belt 3.

The image forming apparatus 100 includes a primary transfer roller 31. The primary transfer roller 31 is provided one for each of the colors of cyan, magenta, yellow, and black. That is, a plurality of (four) primary transfer rollers 31 are provided. Each primary transfer roller 31 is arranged in a region inside the inner circumference of the intermediate transfer belt 3. Each primary transfer roller 31 is arranged, across the intermediate transfer belt 3, opposite the photosensitive drum 11 of the corresponding color.

The image forming apparatus 100 includes a secondary transfer roller 32. The secondary transfer roller 32 is in pressed contact with the outer circumferential face of the intermediate transfer belt 3 at the transfer position P1. The secondary transfer roller 32 holds the intermediate transfer belt 3 against the driving roller 301 to form a transfer nip with the intermediate transfer belt 3. At the transfer position P1, the transfer nip is formed. The main conveying passage MP passes across the transfer nip.

In a print job, a sheet S is conveyed toward the transfer position P1 (that is, the transfer nip). The sheet S being conveyed passes through the transfer nip. That is, the intermediate transfer belt 3 makes contact with the sheet S being conveyed at a position downstream of the contact positions with the photosensitive drums 11 in the rotation direction of the intermediate transfer belt 3.

Each of the image forming portions 1 forms a toner image of the corresponding color. Each of the primary transfer rollers 31 primarily transfers the toner image to the outer circumferential face of the intermediate transfer belt 3. That is, the intermediate transfer belt 3 has toner images primarily transferred from the photosensitive drums 11.

The intermediate transfer belt 3 rotates while carrying on its outer circumferential face the toner images primarily transferred from the photosensitive drums 11. When the sheet S passes through the transfer nip, the sheet S makes contact with the outer circumferential face of the intermediate transfer belt 3. The secondary transfer roller 32 is fed with a transfer voltage from a transfer voltage power supply (not shown). The secondary transfer roller 32 forms a transferring electric field between it and the intermediate transfer belt 3 and thereby secondarily transfers the toner images to a sheet S passing through the transfer nip.

The image forming apparatus 100 includes a cleaning portion 4. The cleaning portion 4 is arranged so as to face the outer circumferential face of the intermediate transfer belt 3. The cleaning portion 4 is arranged downstream of the transfer position P1 in the rotation direction of the intermediate transfer belt 3. The cleaning portion 4 cleans the outer circumferential face of the intermediate transfer belt 3. Specifically, the cleaning portion 4 has a blade (not shown) that makes contact with the outer circumferential face of the intermediate transfer belt 3. The blade of the cleaning portion 4 removes toner that remains, without being transferred to the intermediate transfer belt 3, on the outer circumferential face of the intermediate transfer belt 3.

The image forming apparatus 100 also includes a fixing portion 10. The fixing portion 10 includes a heating roller and a pressing roller. The fixing portion 10 is arranged at the fixing position P2. The heating roller incorporates a heater. The pressing roller is kept in pressed contact with the heating roller. The heating roller and the pressing roller are kept in pressed contact with each other to form a fixing nip at the fixing position P2.

In a print job, a sheet S having a toner image transferred to it passes across the fixing position P2. That is, the sheet S is held at the fixing nip between the heating roller and the pressing roller. The fixing portion 10 heats the sheet S passing across the fixing position P2. At the fixing position P2, the sheet S is pressed. The fixing portion 10 heats and presses the sheet S having the toner image transferred to it to fix the toner image to the sheet S. After fixing, the sheet S is discharged onto the discharge tray ET.

The image forming apparatus 100 includes, although not identified by any reference sign, a conveying portion. The conveying portion includes a pair of conveying rollers. The pair of conveying rollers includes a pair of rollers. The pair of rollers has a conveying nip between them. The pair of conveying rollers rotates to convey a sheet S that has entered the conveying nip. The conveying portion conveys the sheet S along the main conveying passage MP. The conveying portion conveys the sheet S along a duplex printing conveying passage DP, which will be described later.

As a print job, the image forming apparatus 100 can perform, in addition to a simplex print job in which a toner image is printed only on one side of the sheet S, a duplex print job in which a toner image is printed on each side of the sheet S. For a duplex print job, the image forming apparatus 100 includes the duplex printing conveying passage DP.

The duplex printing conveying passage DP branches from the main conveying passage MP at a branch position P3 on it downstream of the fixing position P2 in the sheet conveying direction. Then, the duplex printing conveying passage DP joins the main conveying passage MP at a merge position P4 on it upstream of the transfer position P1 in the sheet conveying direction.

When a job to be executed is a simplex print job, a sheet S passes through the transfer nip only once, and transfer is performed once on the sheet S that is passing through the transfer nip. After first-time fixing, the sheet S is directly discharged onto the discharge tray ET.

When a job to be executed is a duplex print job, transfer is performed once on cach of the obverse and reverse sides of a sheet S; thus, the sheet S passes through the transfer nip twice. Specifically, when the sheet S passes through the transfer nip for the first time, transfer is performed to one side of the sheet S. Subsequently to first-time transfer, after the rear end of the sheet S passes across the branch position P3, before the sheet S is completely discharged onto the discharge tray ET, the sheet S is switched back to be drawn, from its rear end, into the duplex printing conveying passage DP.

Then, the sheet S is conveyed along the duplex printing conveying passage DP. The sheet S in the duplex printing conveying passage DP is conveyed, at the merge position P4, back to the main conveying passage MP. The sheet S having been conveyed back to the main conveying passage MP is conveyed along the main conveying passage MP and passes through the transfer nip again. Here, the sheet S has its obverse and reverse sides reversed compared to when it passed through the transfer nip last time. Thus, when the sheet S passes through the transfer nip for the second time, transfer is performed on the other side, that is, the reverse side, of the sheet S.

The image forming apparatus 100 includes a control portion 6. The control portion 6 includes processing circuits such as a CPU and an ASIC. The control portion 6 includes storage devices such as a ROM and a RAM. The control portion 6 controls print jobs performed on the image forming apparatus 100.

<Structure of a Developing Device>

Now, with reference to FIGS. 2 to 5, the structure of the developing devices 2 will be described with focus on one of them. The developing devices 2 have basically similar structures; thus, for the structure of the other developing devices 2, reference is to be made to the following description and no overlapping description will be repeated.

As shown in FIG. 2, the developing device 2 is arranged so as to face the outer circumferential face of the photosensitive drum 11. Specifically, the developing device 2 is arranged such that the outer circumferential face of a developing roller 20, which will be described later, faces the outer circumferential face of the photosensitive drum 11. In other words, the developing roller 20, described later, is arranged adjacent to the photosensitive drum 11. The developing device 2 may be removably mounted in the main body of the image forming apparatus 100.

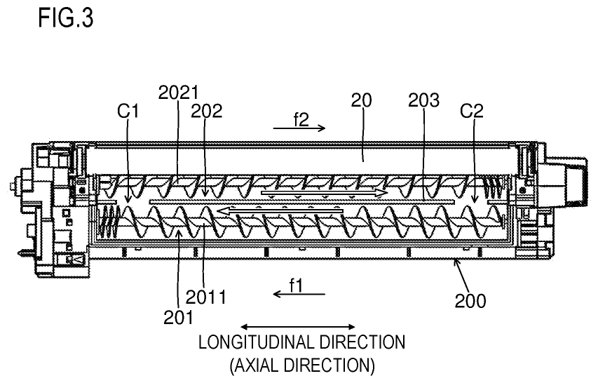

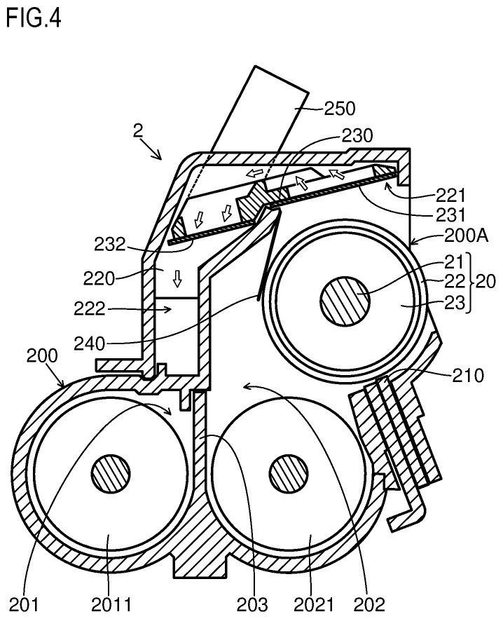

The developing device 2 is structured as shown in FIGS. 3 and 4. The developing device 2 includes a developing roller 20. The developing device 2 also includes a developer container 200. The developer container 200 stores developer containing toner. In other words, the developer container 200 stores toner to be fed to the photosensitive drum 11. The developer stored in the developer container 200 is, for example, magnetic one-component developer containing magnetic toner.

The developing roller 20 is arranged inside the developer container 200. The developer container 200 has an opening 200A at a position facing the photosensitive drum 11. The developing roller 20 has part of its outer circumferential face exposed out of the developer container 200 through the opening 200A. The developing roller 20 carries toner on its outer circumferential face to feed it to the outer circumferential face of the photosensitive drum 11. The developing roller 20 corresponds to a “developer carrying member”.

The developer container 200 extends in the direction parallel to the axis of the photosensitive drum 11 (that is, the rotary shaft of the photosensitive drum 11). That is, the developer container 200 is a container of which the longitudinal direction coincides with the direction parallel to the axis of the photosensitive drum 11. The developer container 200 is arranged such that its longitudinal direction coincides with the horizontal direction.

The developer container 200 has a first stirring chamber 201 and a second stirring chamber 202. The first and second stirring chambers 201 and 202 are separated by a partition portion 203. The developer container 200 includes a first communication portion C1 and a second communication portion C2.

The first and second conveying chambers 201 and 202 are provided inside the developer container 200. The partition portion 203 is disposed inside the developer container 200 generally upright from a bottom part of it and extends in the direction parallel to the axis of the photosensitive drum 11. That is, the partition portion 203 partitions the inside of the developer container 200 in the direction perpendicular to the axial direction of the photosensitive drum 11. Of the inside of the developer container 200, the part on one side of the partition portion 203 in the direction perpendicular to the axial direction of the photosensitive drum 11 constitutes the first stirring chamber 201, and the part on the other side of the partition portion 203 in the direction perpendicular to the axial direction of the photosensitive drum 11 constitutes the second stirring chamber 202.

The first stirring chamber 201 is connected to a developer supply pipe (not shown). The first stirring chamber 201 is supplied with developer via the developer supply pipe.

In the first stirring chamber 201, a first stirring screw 2011 is arranged. In the second stirring chamber 202, a second stirring screw 2021 is arranged. The first and second stirring screws 2011 and 2021 are each structured such that a blade is wound in a helical shape around its rotary shaft that extends parallel to the axis of the photosensitive drum 11. The first stirring screw 2011 rotates to convey developer while stirring it in a first direction f1 (see FIG. 3). The second stirring screw 2021 rotates and thereby conveys developer while stirring it in a second direction f2 (see FIG. 3). In FIG. 3, the developer conveying directions in the first and second conveying chambers 201 and 202 are indicated by hollow arrows.

The first communication portion C1 is provided at the downstream end in the first direction f1 (that is, the upstream end in the second direction f2), and the second communication portion C2 is provided at the downstream end in the second direction f2 (that is, the upstream end in the first direction f1). Through the first communication portion C1, the downstream end of the first stirring chamber 201 in the first direction f1 and the upstream end of the second stirring chamber 202 in the second direction f2 communicate with each other. Through the second communication portion C2, the downstream end of the second stirring chamber 202 in the second direction f2 and the upstream end of the first stirring chamber 201 in the first direction f1 communicate with each other. Through the first communication portion C1, developer is conveyed from the first stirring chamber 201 toward the second stirring chamber 202. Through the second communication portion C2, developer is conveyed from the second stirring chamber 202 toward the first stirring chamber 201.

The developing roller 20 is arranged inside the developer container 200, at a position opposite the photosensitive drum 11. The developer container 200 has an opening 200A at a position where the developing roller 20 faces the photosensitive drum 11. Thus, no part of the side wall forming the developer container 200 lies between the developing roller 20 and the photosensitive drum 11.

The developing roller 20 is arranged inside the developer container 200, above the second stirring screw 2021. Although the developing roller 20 is arranged inside the developer container 200, part of it is exposed out of the developer container 200 through the opening 200A. The part of the outer circumferential face of the developing roller 20 that is exposed out of the developer container 200 faces the outer circumferential face of the photosensitive drum 11.

The developing roller 20, in its area facing the photosensitive drum 11, holds toner on its outer circumferential face to feed it to the photosensitive drum 11. The toner in the second stirring chamber 202 in the developer container 200 is fed from the developing roller 20 to the photosensitive drum 11. The toner fed to the photosensitive drum 11 attaches to an electrostatic latent image on the outer circumferential face of the photosensitive drum 11, and the electrostatic latent image is developed into a toner image.

The developing roller 20 is rotatably supported. Specifically, the developing roller 20 is supported such that its outer circumferential face rotates about an axis that extends parallel to the axis of the photosensitive drum 11. In FIGS. 2 and 4, the developing roller 20 rotates counter-clockwise.

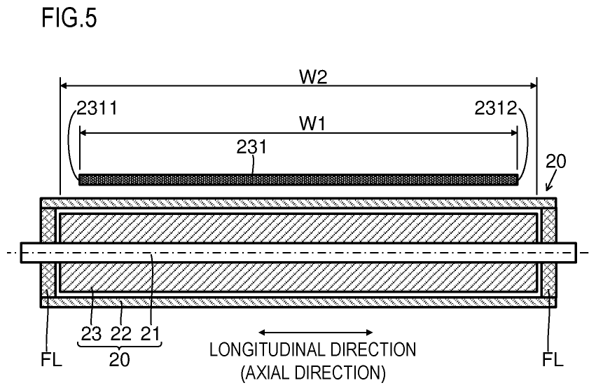

The developing roller 20 is arranged inside the developer container 200 such that its axis is parallel to the axis of the photosensitive drum 11. The developing roller 20 includes a shaft 21, a sleeve 22, and a magnet 23. FIG. 5 is a sectional view of the developing roller 20 cut along a plane including its axis. FIG. 5 is a diagram schematically showing the sectional structure of the developing roller 20, and its shape, dimension, etc. as shown there do not reflect the actual structure.

The shaft 21 extends parallel to the axis of the photosensitive drum 11. That is, the developer container 200 is formed such that its longitudinal direction coincides with the direction parallel to the axis of the shaft 21.

The sleeve 22 is formed in a cylindrical shape that extends along the axis of the shaft 21. The shaft 21 is inserted in the sleeve 22. The sleeve 22 is supported so as to be rotatable about the shaft 21, about its axis. For example, at each of the opposite ends of the shaft 21 in the axial direction, a flange FL that is rotatable on the shaft 21 is arranged. The flange FL rotates by receiving a driving force from an unillustrated motor. The sleeve 22 is fixed to the flange FL and rotates together with it.

The sleeve 22 has an outer circumferential face that faces the photosensitive drum 11. That is, the outer circumferential face of the sleeve 22 constitutes the outer circumferential face of the developing roller 20. The sleeve 22 rotates while carrying toner on its outer circumferential face and feeds the toner to the photosensitive drum 11.

The magnet 23 is arranged inside the sleeve 22. The magnet 23 is fixed to the circumferential face of the shaft 21 and extends along the axis of the shaft 21. The magnet 23 has a plurality of magnetic poles in the circumferential direction of the shaft 21. With the magnetic force of the magnet 23, toner is held on the outer circumferential face of the developing roller 20 (that is, the outer circumferential face of the sleeve 22), and a magnetic brush is formed on the outer circumferential face of the developing roller 20.

The developing device 2 includes a regulating blade 210. The regulating blade 210 is arranged upstream of a region where the developing roller 20 and the photosensitive drum 11 face each other in the rotation direction of the developing roller 20. The regulating blade 210 extends over the entire region of the developing roller 20 in the axial direction of the developing roller 20 (that is, in the axial direction of the shaft 21).

The regulating blade 210 is arranged such that a tip end part of it lies close to the outer circumferential face of the developing roller 20 (that is, the outer circumferential face of the sleeve 22). The tip end part of the regulating blade 210 faces the outer circumferential face of the developing roller 20 across a predetermined distance.

As the first and second stirring screws 2011 and 2021 rotate, the developer stored in the developer container 200 circulates between the first and second stirring chambers 201 and 202 through the first and second communication portions C1 and C2. Meanwhile, the developer in the developer container 200 is, by being stirred, electrostatically charged and held on the outer circumferential face of the developing roller 20 to form a magnetic brush. As the magnetic brush passes between the outer circumferential face of the developing roller 20 and the regulating blade 210, it is regulated to have a predetermined layer thickness.

Then, as the developing roller 20 rotates, the magnetic brush is conveyed to a region where the developing roller 20 and the photosensitive drum 11 face each other. Here, the developing roller 20 is fed with a predetermined developing voltage. This produces a potential difference between the developing roller 20 and the photosensitive drum 11, and the toner in the magnetic brush is supplied to the photosensitive drum 11.

<Toner Collection Mechanism Around the Developing Roller>

Now, with reference to FIGS. 4 and 5, a toner collection mechanism for collecting scattered toner around the developing roller 20 will be described. The toner collection mechanisms in the developing devices 2 have basically similar structures. Thus, hereinafter, their structures will be described with focus on the toner collection mechanism in one developing device 2. For the toner collection mechanisms in the other developing devices 2, reference is to be made to the following description and no overlapping description will be repeated.

The developer container 200 includes a duct 220, an intake port 221, and an exhaust port 222. The developer container 200 also includes a first filter 231 and a second filter 232.

The duct 220 lets the air in the developer container 200 flow out of it. In FIG. 4, the air circulation direction in the duct 220 is indicated by hollow arrows.

The duct 220 is arranged adjacent to the second stirring chamber 202. The duct 220 faces the photosensitive drum 11 across the region in the developer container 200 where the developing roller 20 is arranged, in a direction intersecting the longitudinal direction of the developer container 200 (that is, the axial direction of the developing roller 20). The duct 220 is connected to inside the developer container 200. Specifically, the duct 220 is connected to the second stirring chamber 202. The duct 220 lets the air in the second stirring chamber 202 flow out of it.

The intake port 221 is an opening through which the inside of the developer container 200 (that is, the inside of the second stirring chamber 202) and the inside of the duct 220 communicate with each other and that is located at the upstream end of the duct 220 in the air circulation direction. The intake port 221 is formed in an upper part of the second stirring chamber 202 so as to be open above the developing roller 20. That is, the intake port 221 faces the developing roller 20. Through the intake port 221, the air in the developer container 200 flows into the duct 220.

The intake port 221 is formed in a rectangular shape of which the longitudinal direction coincides with the direction parallel to the axis of the developing roller 20 (that is, the direction parallel to the axis of the shaft 21). Here, the width of the intake port 221 in the longitudinal direction is smaller than that of the magnet 23 in the longitudinal direction (that is, in the axial direction of the shaft 21). That is, the inner edge of the intake port 221 at one side in the longitudinal direction is located inward of the edge of the magnet 23 at the same side (closer to the middle of the magnet 23 in the longitudinal direction), and the inner edge of the intake port 221 at the other side in the longitudinal direction is located inward of the edge of the magnet 23 at the same side.

The exhaust port 222 is arranged, for example, in a rear part of the developer container 200. The exhaust port 222 allows the inside and the outside of the duct 220 to communicate with each other. The air in the duct 220 flows out of it through the exhaust port 222.

Although not illustrated, the exhaust port 222 may be connected to any other exhaust path provided in the main body of the image forming apparatus 100. Furthermore, such another exhaust path may be connected to an exhaust fan. Then, driving the exhaust fan permits the air sucked into the developer container 200 to be forcibly discharged outside through the duct 220.

The first filter 231 is arranged in the intake port 221. The first filter 231 collects developer contained in the air that flows out of the developer container 200 into the duct 220.

The first filter 231 covers the entire region of the intake port 221 with no gap as seen from a direction in which the intake port 221 is open. The first filter 231 has an outline that substantially coincides with the shape of the opening of the intake port 221 so as to cover the entire region of the intake port 221. That is, the first filter 231 is formed in a rectangular shape of which the longitudinal direction coincides with the direction parallel to the axis of the developing roller 20 (that is, the direction parallel to the axis of the shaft 21).

For example, the first filter 231 is made of a non-woven fabric and is formed by needle punching. The non-woven fabric that forms the first filter 231 is made of fibers having a round section with a fiber diameter of 10 μm to 20 μm. The non-woven fabric that forms the first filter 231 has a thickness of about 1 mm.

The second filter 232 is arranged in the duct 220. That is, the second filter 232 is arranged downstream of the first filter 231 in the air circulation direction in the duct 220. The second filter 232 collects developer contained in the air that has passed through the first filter 231.

The second filter 232 has an outline that substantially coincides with the shape of the opening in a direction intersecting the air circulation direction in the duct 220. Thus, the air circulation path in the duct 220 is blocked by the second filter 232.

For example, the second filter 232 is made of a non-woven fabric and is formed by spun-bonding. The non-woven fabric that forms the second filter 232 is made of fibers having a round section with a fiber diameter of 20 μm to 40 μm. The non-woven fabric that forms the second filter 232 has a thickness of about 0.2 mm.

The second filter 232 has a finer mesh than the first filter 231. In other words, the second filter 232 has developer collecting efficiency than the first filter 231. In yet other words, a filter with lower developer collecting efficiency than the second filter 232 is used as the first filter 231. In this way, it is possible to prevent the first filter 231 from collecting a large amount of developer, and this helps suppress clogging in the first filter 231. Even if the first filter 231 has low developer collecting efficiency, arranging the second filter 232 downstream of the first filter 231 in the air circulation direction helps prevent the developer from leaking out of the developer container 200.

The developer container 200 includes a blocking member 240. The blocking member 240 is a film-form member. The blocking member 240 is formed of a PET plate made from PET resin (polyethylene terephthalate). The blocking member 240 is formed in a rectangular shape of which the longitudinal direction coincides with the direction parallel to the axis of the developing roller 20 (that is, the direction parallel to the axis of the shaft 21).

The blocking member 240 blocks the air circulation path in the developer container 200 leading from the second stirring chamber 202 via the space between the inner wall of the developer container 200 and the outer circumferential face of the developing roller 20 (that is, the outer circumferential face of the sleeve 22) to the intake port 221. The blocking member 240 blocks circulation of air flowing from the position in the second stirring chamber 202 where the second stirring screw 2021 is provided via the space between the inner wall of the developer container 200 and the outer circumferential face of the developing roller 20 toward the intake port 221.

The blocking member 240 is fitted to the inner wall of the developer container 200. The blocking member 240 keeps its tip end opposite from its tip end fitted to the inner wall of the developer container 200 in contact with the outer circumferential face of the developing roller 20 (that is, the outer circumferential face of the sleeve 22). In this way, the blocking member 240 blocks the air circulation path leading via the space between the inner wall of the developer container 200 and the outer circumferential face of the developing roller 20 to the intake port 221.

With the blocking member 240, the air circulation path leading from the inside of the developer container 200 (specifically, the second stirring chamber 202) to the intake port 221 is blocked. As a result, it is possible to prevent the developer in the second stirring chamber 202 from being sucked in unnecessarily through the intake port 221.

Here, the developing device 2 includes a vibration generator 250. For example, the vibration generator 250 includes, although not illustrated, a vibration motor, a control circuit board, and the like. The vibration generator 250 is arranged adjacent to the rear face of the developer container 200.

The vibration generator 250 vibrates at least the first filter 231. For example, the vibration generator 250 vibrates both the first and second filters 231 and 232. That is, the vibration generator 250 is connected to both the first and second filters 231 and 232.

With the vibration generator 250 in the developing device 2, by vibrating the first filter 231, it is possible to drop the developer attached to the first filter 231 off from it. That is, it is possible to suppress clogging in the first filter 231. Likewise, by vibrating the second filter 232, it is also possible to suppress clogging in the second filter 232.

For example, the developer container 200 includes a holding member 230. The holding member 230 holds the first and second filters 231 and 232. The vibration generator 250 is connected to the holding member 230. That is, the vibration generator 250 vibrates the holding member 230. In this way, it is possible to vibrate both the first and second filters 231 and 232.

<Position where a First Filter is Arranged>

The position where the first filter 231 is arranged will be described below with reference to FIG. 5. The position where the first filter 231 is arranged is determined based on the positional relationship between the developing roller 20 and the magnet 23.

In the following description, the farthest edge of the first filter 231 at one side in the longitudinal direction is identified by the reference sign 2311 and referred to as a first edge 2311, and the farthest edge of the first filter 231 at the other side in the longitudinal direction is identified by the reference sign 2312 and referred to as a second edge 2312. The longitudinal direction of the first filter 231 corresponds to the axial direction of the developing roller 20 and is parallel to the axis of the developing roller 20 (that is, the direction parallel to the axis of the shaft 21). The magnet 23 extends along the axis of the shaft 21. Thus, the longitudinal direction of the magnet 23 is the direction parallel to the axis of the developing roller 20 (that is, the direction parallel to the axis of the shaft 21).

In the following description, the width of the first filter 231 in the longitudinal direction (that is, the width from the first edge 2311 to the second edge 2312) is referred to as a width W1. The width of the magnet 23 in the longitudinal direction is referred to as a width W2.

The width W1 of the first filter 231 is equal to or smaller than the width W2 of the magnet 23. The width W1 of the first filter 231 may be smaller than the width W2 of the magnet 23 or be equal to the width W2 of the magnet 23. In FIG. 5, the width W1 of the first filter 231 is illustrated to be smaller than the width W2 of the magnet 23.

Here, the first and second edges 2311 and 2312 are both located within a range opposite the magnet 23 as seen from the direction perpendicular to the axial direction of the developing roller 20 (that is, the direction parallel to the axial direction of the shaft 21). As viewed from the direction perpendicular to the axial direction of the developing roller 20, the sleeve 22 is present between the first filter 231 and the magnet 23. That is, the first filter 231 faces the magnet 23 across the sleeve 22 over the entire region as seen from the direction perpendicular to the axial direction of the developing roller 20.

In other words, the first edge 2311, which is the edge of the first filter 231 at one side in the longitudinal direction, does not project beyond the edge of the magnet 23 at one side (the same side) in the longitudinal direction toward the one side (out ward) in the longitudinal direction. The second edge 2312, which is the edge of the first filter 231 at the other side in the longitudinal direction, does not project beyond the edge of the magnet 23 at the other side (the same side) in the longitudinal direction toward the other side (outward) in the longitudinal direction.

For example, as shown in FIG. 5, when the width W1 of the first filter 231 is smaller than the width W2 of the magnet 23, the first edge 2311 can be set inward of the edge of the magnet 23 at the same side and the second edge 2312 can be set inward of the edge of the magnet 23 at the same side. Although not illustrated, it is also possible to set one of the first and second edges 2311 and 2312 inward of the edge of the magnet 23 at the same side and the other at a position coinciding with the edge of the magnet 23 at the same side.

Although not illustrated, when the width W1 of the first filter 231 is equal to the width W2 of the magnet 23, the first edge 2311 can be set at a position coinciding with the edge of the magnet 23 at the same side and the second edge 2312 can be set at a position coinciding with the edge of the magnet 23 at the same side.

With the configuration according to the embodiment, when the developer attached to the first filter 231 drops from the first filter 231, it is possible to prevent the developer from scattering out of the developer container 200. Specifically, on the sleeve 22 of the developing roller 20, in a range opposite the magnet 23, a magnetic brush is formed. Thus, when the first and second edges 2311 and 2312 of the first filter 231 are located, as viewed from the direction perpendicular to the axial direction of the developing roller 20, within the range opposite the magnet 23, that means that the first and second edges 2311 and 2312 are both located within the range opposite the magnetic brush. In other words, as viewed from the direction perpendicular to the axial direction of the developing roller 20, the entire region of the first filter 231 faces the magnetic brush.

Since the first filter 231 is located above the developing roller 20 and the magnetic brush is formed below the first filter, the developer that drops from the first filter 231 heads toward the magnetic brush. When the developer drops from the first filter 231, it is absorbed into the magnetic brush. When, as viewed from the direction perpendicular to the axial direction of the developing roller 20, the first and second edges 2311 and 2312 of the first filter 231 are both located within the range opposite the magnet 23, less developer is left unabsorbed into the magnetic brush, and this helps prevent the developer from scattering out of the developer container 200. In particular, it is possible to suppress scattering of the developer out of the developer container 200 at opposite ends of the developer container 200 in the longitudinal direction. As a result, it is possible to prevent the inside of the image forming apparatus 100 from being soiled with the developer that scatters out of the developer container 200.

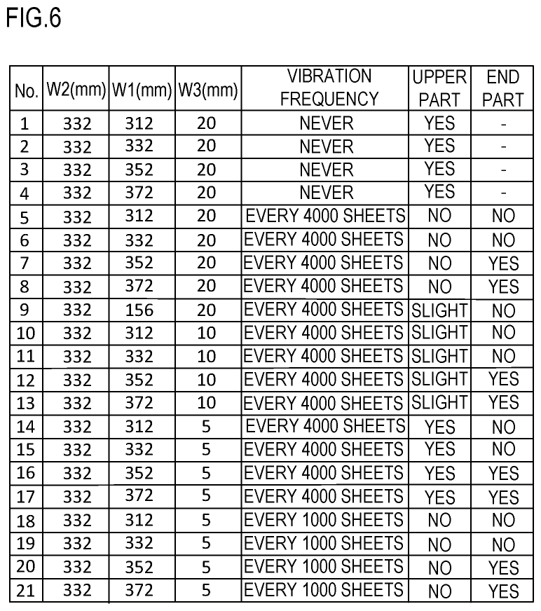

Hereinafter, a description will be given of tests performed to confirm the effect described above. The results of the tests are shown in FIG. 6.

In the confirmation-tests, as the first filter 231, a non-woven fabric made of fibers having a round section with a fiber diameter of 10 μm to 20 μm was used. As the second filter 232, a non-woven fabric made of fibers having a round section with a fiber diameter of 20 μm to 40 μm was used.

In the confirmation-tests, a developing roller 20 including a magnet 23 having a width W2 of 332 mm in the longitudinal direction was used. Furthermore, in the confirming test, the width W1 of the first filter 231 in the longitudinal direction was varied within the range of 156 mm to 372 mm, and the width (marked as W3 in FIG. 6) of the first filter 231 in the lateral direction was varied within the range of 5 mm to 20 mm. That is, in the confirmation-tests, a plurality of types of first filters 231 with different sizes (shapes) were used. The sizes (shapes of the opening) of the intake port 221 in the longitudinal and lateral directions were adapted to the size of the first filter 231 used.

In the confirmation-tests, with a plurality of types of structures varying in the size of the first filter 231 (the size of the intake port 221), printing at a printing rate of 20% was performed on 600,000 sheets; thereafter, how developer scattered out of the developer container 200 was visually checked.

In the confirmation-tests, as shown in FIG. 6. Test 1 to 21 were performed. The size of the first filter 231 varied among tests. In the confirmation-tests, the first filter 231 was vibrated at various timings. Specifically, in Test 1 to 4, the first filter 231 was not vibrated. In Tests 5 to 17, the first filter 231 was vibrated every time 4000 sheets were printed. In Tests 18 to 21, the first filter 231 was vibrated every time 1000 sheets were printed.

In the confirmation-tests, soiling with scattered developer in an upper part of the developer container 200 (hereinafter, referred to as upper part scattering, and, in FIG. 6, marked simply as UPPER PART) was visually checked, and soiling with scattered developer in end parts of the developer container 200 in the longitudinal direction (hereinafter, referred to as end part scattering, and, in FIG. 6, marked simply as END PART) was visually checked. For UPPER PART SCATTERING in FIG. 6, when substantially no soiling with scattered developer occurred, it was evaluated as “NO”, when slight soiling with scattered developer occurred, it was evaluated as “SLIGHT”, and when evident soiling with scattered developer occurred, it was evaluated as “YES”. For END PART SCATTERING in FIG. 6, when substantially no soiling with scattered developer occurred, it was evaluated as “NO”, and when evident soiling with scattered developer occurred, it was evaluated as “YES”.

In Tests 1 to 4, regardless of the size of the first filter 231, soiling with scattered developer occurred in an upper part of the developer container 200. In Tests 1 to 4, the first filter 231 was not vibrated. By contrast, in Test 5 to 21, the first filter 231 was vibrated. When the first filter 231 was vibrated, soiling did occasionally occur, but in a comparatively suppressed manner. The soiling in Test 1 to 4 is considered to have occurred because the developer attached to the first filter 231 remained and clogged the first filter 231. These results confirm that vibrating the first filter 231 drops the developer attached to the first filter 231 off from it and this helps suppress clogging in the first filter 231.

In Tests 5 and 6, the first and second edges 2311 and 2312 were arranged, as viewed from the direction perpendicular to the axial direction of the developing roller 20, within the range opposite the magnet 23. Specifically, with respect to the width W2 (=332 mm) of the magnet 23 in the longitudinal direction, the width W1 of the first filter 231 in the longitudinal direction was set to 312 mm in Test 5 and to 332 mm in Test 6.

By contrast, in Test 7 and 8, at least one of the first and second edges 2311 and 2312 was not arranged, as viewed from the direction perpendicular to the axial direction of the developing roller 20, within the range opposite the magnet 23. Specifically, the width W1 of the first filter 231 in the longitudinal direction was set to 352 mm in Test 7 and to 372 mm in Test 8.

In Tests 5 and 6, no soiling by upper part scattering occurred. Furthermore, in Test 5 and 6, no soiling by end part scattering occurred. By contrast, in Test 7 and 8, although no soiling by upper part scattering occurred, soiling by end part scattering occurred. In Tests 5 to 8, the first filter 231 vibrated at an equal frequency. In all of Test 5 to 8, the width of the first filters 231 in the lateral direction was equal, specifically 20 mm.

These results confirm that arranging the first and second edges 2311 and 2312 within the range opposite the magnet 23 as viewed from the direction perpendicular to the axial direction of the developing roller 20 helps prevent developer from scattering out of the developer container 200 at opposite ends of the developer container 200 in the longitudinal direction. That is, it can be understood that more of the developer that has dropped from the first filter 231 was absorbed into the magnetic brush in Tests 5 and 6 than in Tests 7 and 8.

In Test 9, as in Test 5 and 6, the first filter 231 was vibrated every time 4000 sheets were printed. The width of the first filter 231 in the lateral direction was set to 20 mm. By contrast, in Test 9, the width W1 of the first filter 231 in the longitudinal direction was reduced to 156 mm.

In Test 9, slight soiling by upper part scattering occurred, and, in this regard, the result was poorer than in Test 5 and 6. This is considered to be because the filter area of the first filter 231 (that is, the area of the intake port 221) was too small to eliminate clogging with vibration at the same frequency as in other tests. However, in Test 9, as in Test 5 and 6, no soiling by end part scattering occurred. This confirms that, even if the width W1 of the first filter 231 in the longitudinal direction (that is, the width of the intake port 221 in the longitudinal direction) is comparatively small, the expected effect can still be obtained.

However, reducing the width W1 of the first filter 231 in the longitudinal direction means reducing the filter area of the first filter 231. That is, the smaller the width W1 of the first filter 231 in the longitudinal direction, the more likely clogging occurs. Even so, by increasing the frequency of vibration in the first filter 231, it is possible to suppress clogging in the first filter 231.

For example, the result of Test 9 reveals the following: when the width W1 of the first filter 231 in the longitudinal direction is 156 mm, vibrating the first filter 231 every time 4000 sheets are printed helps suppress clogging in the first filter 231. Thus, it can be understood that, when the width W1 of the first filter 231 in the longitudinal direction is 110 mm (that is, about one third of the width of the magnet 23 in the longitudinal direction), changing the frequency of vibration of the first filter 231 to every 2000 to 3000 printed sheets helps suppress clogging in the first filter 231.

Thus, it is preferable that the width W1 of the first filter 231 in the longitudinal direction be equal to or longer than one third of the width of the magnet 23 in the longitudinal direction. If the width W1 of the first filter 231 in the longitudinal direction is smaller than one third of the width of the magnet 23 in the longitudinal direction, inconveniently, vibration needs to be performed frequently to suppress clogging. Thus, it is impractical to make the width W1 of the first filter 231 in the longitudinal direction too small.

In Tests 10 to 13, the width of the first filter 231 in the lateral direction was smaller than in Tests 1 to 9. While, in Tests 1 to 9, the width of the first filter 231 in the lateral direction was 20 mm, in Tests 10 to 13, the width of the first filter 231 in the lateral direction was 10 mm.

In Tests 10 and 11, the width W1 of the first filter 231 in the longitudinal direction was 312 mm to 332 mm, and the first and second edges 2311 and 2312 were arranged, as viewed from the direction perpendicular to the axial direction of the developing roller 20, within the range opposite the magnet 23. In Tests 12 and 13, the width W1 of the first filter 231 in the longitudinal direction was 352 mm to 372 mm, and at least one of the first and second edges 2311 and 2312 was not arranged, as viewed from the direction perpendicular to the axial direction of the developing roller 20, within the range opposite the magnet 23.

In Tests 10 to 13, the first filter 231 was vibrated every time 4000 sheets were printed. That is, in Tests 10 to 13, the first filter 231 was vibrated at the same frequency as in Tests 5 to 9.

In Tests 10 to 13, slight soiling by upper part scattering occurred. However, in Test 10 and 11, no soiling by end part scattering occurred. By contrast, in Test 12 and 13, soiling by end part scattering occurred. Also these results confirm that arranging the first and second edges 2311 and 2312 within the range opposite the magnet 23 as viewed from the direction perpendicular to the axial direction of the developing roller 20 helps prevent developer from scattering out of the developer container 200 at opposite ends of the developer container 200 in the longitudinal direction.

In Tests 14 to 17, the width of the first filter 231 in the lateral direction was smaller than in Tests 10 to 13. In Tests 14 to 17, the width of the first filter 231 in the lateral direction was set to 5 mm.

In Tests 14 and 15, the width W1 of the first filter 231 in the longitudinal direction was 312 mm to 332 mm, and the first and second edges 2311 and 2312 were arranged, as viewed from the direction perpendicular to the axial direction of the developing roller 20, within the range opposite the magnet 23. In Tests 16 and 17, the width W1 of the first filter 231 in the longitudinal direction was 352 mm to 372 mm, and at least one of the first and second edges 2311 and 2312 was not arranged, as viewed from the direction perpendicular to the axial direction of the developing roller 20, within the range opposite the magnet 23.

In Tests 14 to 17, the first filter 231 was vibrated every time 4000 sheets were printed. That is, in Tests 14 to 17, the first filter 231 was vibrated at the same frequency as in Tests 5 to 13.

In Tests 14 to 17, soiling by upper part scattering occurred. From these results, it can be understood that the smaller the filter area of the first filter 231, the more likely clogging in the first filter 231 occurs, and the more developer scatters out of the developer container 200.

However, while, in Tests 14 and 15, no soiling by end part scattering occurred, in Tests 16 and 17, soiling by end part scattering occurred. These results confirm that arranging the first and second edges 2311 and 2312 within the range opposite the magnet 23 as viewed from the direction perpendicular to the axial direction of the developing roller 20 helps prevent developer from scattering out of the developer container 200 at opposite ends of the developer container 200 in the longitudinal direction.

In Tests 18 to 21, as in Tests 14 to 17, the width of the first filter 231 in the lateral direction was smaller than in Tests 10 to 13. In Tests 18 to 21, the width of the first filter 231 in the lateral direction was set to 5 mm.

In Tests 18 and 19, the width W1 of the first filter 231 in the longitudinal direction was 312 mm to 332 mm, and the first and second edges 2311 and 2312 were arranged, as viewed from the direction perpendicular to the axial direction of the developing roller 20, within the range opposite the magnet 23. In Tests 20 and 21, the width W1 of the first filter 231 was 352 mm to 372 mm, and at least one of the first and second edges 2311 and 2312 was not arranged, as viewed from the direction perpendicular to the axial direction of the developing roller 20, within the range opposite the magnet 23.

In Tests 18 to 21, the first filter 231 was vibrated every time 1000 sheets were printed. That is, in Tests 18 to 21, the first filter 231 was vibrated more frequently than in Tests 5 to 17.

In Tests 18 and 19, neither soiling by upper part scattering nor soiling by end part scattering occurred. These results confirm that, even if the filter area of the first filter 231 is small, vibrating the first filter 231 more frequently helps suppress scattering of developer out of the developer container 200.

In Tests 20 and 21, soiling by upper part scattering occurred, but no soiling by end part scattering occurred. From these results, it can be understood that an effective way to suppress scattering of developer out of the developer container 200 at opposite ends of the container 200 in the longitudinal direction is to arrange the first and second edges 2311 and 2312, as viewed from the direction perpendicular to the axial direction of the developing roller 20, within the range opposite the magnet 23.

The embodiments disclosed herein should be understood to be in every aspect illustrative and not restrictive. The scope of the present disclosure is not limited by the description of the embodiments given above but by the appended claims, and encompasses any modifications made within a sense and scope equivalent to those of the claims.

What is claimed is:

1. A developing device, comprising:
a developer container that stores developer containing toner, the developer container having an opening at a position facing an image carrying member; and
a developer carrying member that is arranged inside the developer container, the developer carrying member being exposed out of the developer container through the opening, the developer carrying member carrying the toner to feed the toner to the image carrying member,
wherein
the developer carrying member includes:
a shaft;
a sleeve that is supported so as to be rotatable about the shaft, the sleeve rotating while carrying the toner on an outer circumferential face thereof; and
a magnet that is arranged inside the sleeve and that extends along an axis of the developer carrying member,
the developer container includes:
a duct that lets air in the developer container flow out of it;
an intake port that is open above the developer carrying member and through which an inside of the developer container and an inside of the duct communicating with each other; and
a first filter that covers the intake port, and
edges of the first filter at one side and at another side in an axial direction of the developer carrying member are both located within a range opposite the magnet as seen from a direction perpendicular to the axial direction.

2. The developing device according to claim 1, further comprising a vibration generator that vibrates the first filter.

3. The developing device according to claim 1,
wherein
the developer container includes a second filter, and
the second filter is arranged downstream of the first filter in an air circulation direction in the duct.

4. The developing device according to claim 3,
wherein
the second filter has higher developer collecting efficiency than the first filter.

5. The developing device according to claim 1, further comprising a blocking member that blocks an air circulation path leading via a space between an inner wall of the developer container and an outer circumferential face of the developer carrying member to the intake port,
wherein
the blocking member is fitted to the inner wall of the developer container, and
the blocking member keeps a tip end thereof opposite from a tip end thereof fitted to the inner wall of the developer container in contact with the outer circumferential face of the developer carrying member to block the air circulation path.

6. An image forming apparatus comprising the developing device according to claim 1.
